(19) United States
(12) Patent Application Publication
(10) Pub. No.: US 2004/0217236 A1
(43) Pub. Date: Nov. 4, 2004

(54) Vibration-proof clamp

(76) Inventor: Tomio Shibuya, Aichi-ken (JP)

Correspondence Address: HARNESS, DICKEY & PIERCE, P.L.C., P.O. BOX 828, BLOOMFIELD HILLS, MI, 48303, US

(21) Appl. No.: 10/852,957

(22) Filed: May 25, 2004

Related U.S. Application Data
(63) Continuation of application No. PCT/US02/09332, filed on Mar. 27, 2002.

(30) Foreign Application Priority Data
Mar. 28, 2001 (JP) 2001-092898

(51) Int. Cl. F16L 3/22; B60D 1/62

(52) U.S. Cl. 248/68.1; 248/55; 248/634; 285/62

(57) ABSTRACT

A vibration-proof clamp capable of achieving high vibration-proof performance with high reliability.

A vibration-proof clamp comprises a housing member (20) having a rectangular housing space, and an elastic tubing-retaining member (30) for holding a tube body T. The elastic tubing-retaining member is housed in the space of the housing member. The tubing-retaining member includes a plurality of inner tubing-retaining surfaces (36a, b), channels (35a, b) provided between the respective adjacent tubing-retaining surfaces, and a plurality of cavities (37, 38) formed within the tubing-retaining member. When the tube body is vibrated and displaced, the cavity and the channel are operable to absorb the displacement of the tube body so as to provide vibration-proof performance.

### FIELD OF THE INVENTION

The present invention relates to a vibration-proof clamp used for holding and various types of tube bodies to fix them to an automobile body or the like.

### BACKGROUND OF THE INVENTION

Generally, a vibration-proof clamp is used for holding a fuel or brake-fluid tubing of an automobile or the like to fix it an automobile body or the like with insulating vibrations generated in the tubing so as to prevent the vibrations from being transmitted to the body.

FIG. 6 shows a side view of one example of a conventional vibration-proof clamp. This conventional vibration-proof clamp has a plurality of clamp portions A1 and an attaching portion A2 adjacent to the clamp portions. The attaching portion A2 includes a plughole B and an engagement piece C, and allows a stud fixed to an automobile body (not shown) to be inserted thereinto. Each of the clamp portions A1 has a main body 1 formed of a hard resin material, and the main body has a pair of sidewalls and a bottom wall. An insertion opening 3 is defined between the opposed ends of the sidewalls of the main body 1 to allow a tube body T to be passed therethrough in an attaching or detaching operation of the tube body.

The main body 1 also includes a pair of anti-dropping pieces 4 each provided at the corresponding end of the sidewalls. When the tube body T is inserted into the main body 1 through the insertion opening 3, the anti-dropping pieces 4 are pressed and deformed by the tube body. After the tube body T is fitted into a holding body 6 of a vibration-proof member 5, the anti-dropping pieces 4 are returned to their original form. In this state, the anti-dropping pieces 4 act to prevent the tube body T from dropping off.

The vibration-proof member 5 formed of a soft resin material includes the holding body 6 for holding the tube body T fitted thereinto, a pair of coupling pieces 7 for coupling the holding body 6 to the inner surface of the main body 1, and a pair of covering elements 8 for covering a part of the outer surface of the anti-dropping pieces 4.

A cavity portion 10, 11 is formed between the main body 1 and the holding body 6 of the vibration-proof member 5. The cavity portion 10, 11 acts to assure the vibration-proof performance of the vibration-proof member 5.

This conventional vibration-proof clamp provides a high vibration-proof performance. The main body 1 and the holding body 6 are coupled by the covering elements 8 with a relatively large contact area. However, the holding body is coupled to the inner surface of the main body 1 only by the coupling pieces 7 or with a small contact area. Thus, if the soft resin material of the coupling pieces 7 is degraded, the coupling pieces 7 can be released from the main body 1, or can be damaged. In addition, the holding body 6 can be damaged in the vicinity of the lower end of the anti-dropping piece 4. Due to the disadvantageous damage as described above, the conventional vibration-proof clamp has suffered from degradation in reliability.

The present invention is directed to solve this problem. It is therefore an object of the present invention to provide a vibration-proof clamp capable of achieving high vibration-proof performance with high reliability.

### SUMMARY OF THE INVENTION

A vibration-proof clamp of the present invention comprises a housing member having a rectangular housing space, and an elastic tubing-retaining member housed in the space of the housing member and adapted to hold a tube body.

The tubing-retaining member includes a plurality of inner tubing-retaining surfaces, a channel provided between the adjacent tubing-retaining surfaces, and a cavity formed within the tubing-retaining member.

When the tube body is vibrated and displaced, the cavity and the channel are operable to absorb the displacement of the tube body so as to provide vibration-proof performance.

The housing member may include a pair of inclined surfaces each extending from the corresponding upper end thereof obliquely downward to define a tube-body insertion opening between the inclined surfaces.

The tubing-retaining surfaces of the tubing-retaining member may be formed in flat surfaces. Alternatively, the tubing-retaining surfaces may be formed with concave portions conformable with the tube body.

The channel of the tubing-retaining member may be formed to extend in the longitudinal direction of the tube body. The cavity of the tubing-retaining member may be formed to extend in the longitudinal direction of the tube body.

The housing member may include an undercut portion for retaining the tubing-retaining member.

### BRIEF DESCRIPTION OF THE DRAWINGS

FIG. 1 is an end view of a vibration-proof clamp according to an embodiment of the invention.

FIG. 2 is a top view of the vibration-proof clamp according to the embodiment of the invention.

FIG. 3 is an end view of a housing member of the vibration-proof clamp according to the embodiment of the invention.

FIG. 4 and FIG. 4(a) is a sectional view taken along the line A-A of FIG. 3. FIG. 4 (b) illustrates the state when a tubing-retaining member is attached.

FIG. 5 is a schematic diagram showing the movement of the tubing-retaining member when a tube body is vibrated and displaced.

FIG. 6 is an end view of a conventional vibration-proof clamp.

### DETAILED DESCRIPTION OF THE PREFERRED EMBODIMENT

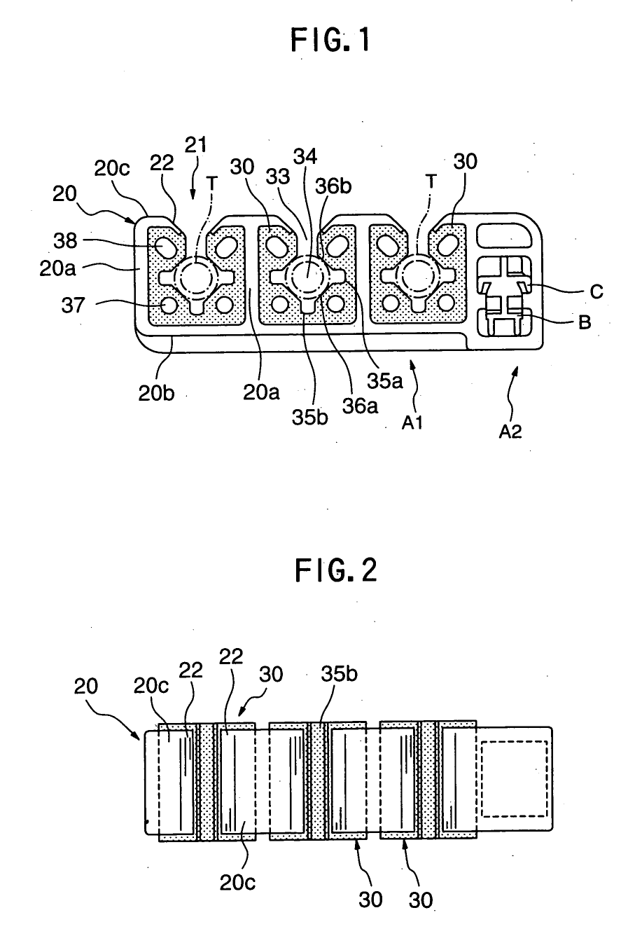

With reference to the drawings, embodiments of the present invention will now be described. FIG. 1 is an end view of a vibration-proof clamp according to a first embodiment of the invention. FIG. 2 is a top view of the vibration-proof clamp. The vibration-proof clamp includes a plurality of clamp portions A1 and an attaching portion A2 adjacent to the clamp portions. The attaching portion A2 includes a plughole B and an engagement piece C, and allows a stud fixed to an automobile body (not shown) to be inserted thereinto. Each of the clamp portions A1 includes a housing member 20 formed of a hard resin material, and a tubing-retaining member 30 for holding a tube body T fitted into the housing member 20.

In each of the clamp portions A1, the housing member 20 formed of a hard resin material has a bottom wall 20b, a pair of sidewalls 20a and a pair of top walls 20c. A rectangular housing space is defined by the bottom wall 20b, the pair of sidewalls 20a and the pair of top walls 20c.

The ends of the top walls 20c of the housing member 20 have a pair of inclined surfaces 22 extending obliquely downward, respectively. An insertion opening 21 is defined between the pair of inclined surfaces 22 of the housing member 20 to allow the tube body T to be passed therethrough in an attaching or detaching operation of the tube body. Each of the inclined surfaces 22 is formed to have a thickness less than the sidewalls 20a and the top walls 20c so as to be elastically deformed when the tube body T passes through the insertion opening 21.

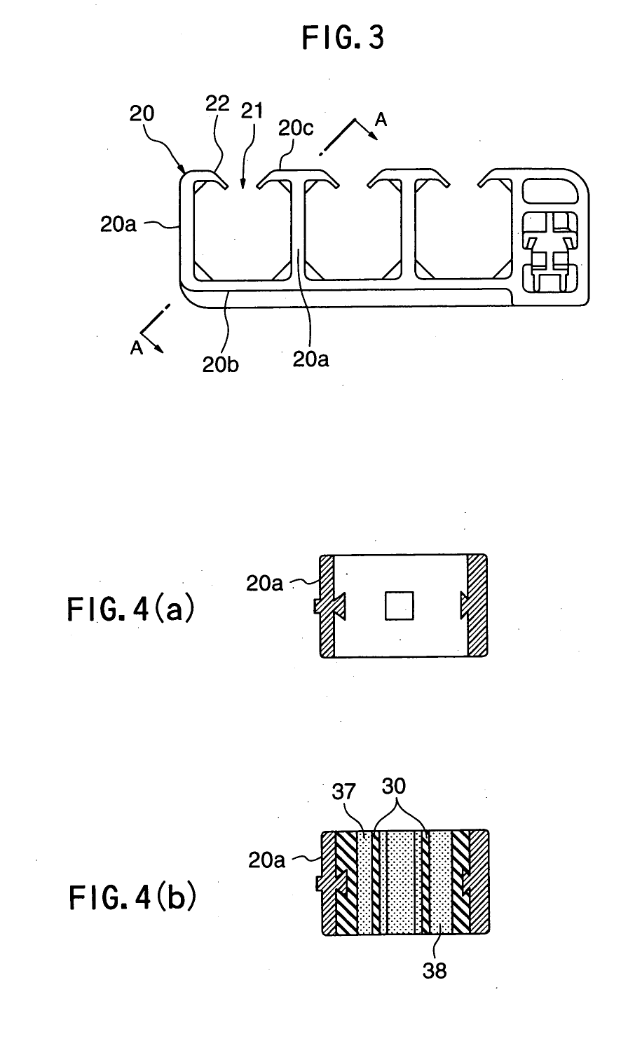

FIG. 3 illustrates the housing member 20 in the state before the tubing-retaining member 30 is attached thereto. FIG. 4(a) is a sectional view taken along the line A-A, wherein the housing member 20 is provided with an undercut portion for reliably retaining the tubing-retaining member 30 when the tubing-retaining member 30 is attached to the housing member later. FIG. 4(b) shows the state when the tubing-retaining member is attached to the housing member.

Returning to FIG. 1, the tubing-retaining member 30 is housed in the inner space of the housing member 20. The tubing-retaining member 30 is formed of an elastic soft resin material, and is in contact with the sidewalls 20a, the bottom wall 20b, the top walls 20c and the inclined surfaces 22. The tubing-retaining member 30 may be made by rubber. An opening 33 is provided in the upper portion of the tubing-retaining member 30 to allowing the tube body T to be passed therethrough in an insertion operation of the tube body. The opening 33 has a width shorter than the outside diameter of the tube body T to allow the tube body to be passed therethrough by a push-in operation but to prevent the tube body installed in place from being readily pulled out therethrough.

A bottom channel 35b is formed in the bottom surface of the tubing-retaining member 30, and a side channel 35a is formed in each of the side surfaces of the tubing-retaining member 30. A downward inclined surface 36a as a tubing-retaining surface is formed between the bottom channel 35b and each of the two side channels 35a. Further, an upward inclined surface 36b as a tubing-retaining surface is formed between the top opening 33 and each of the two side channels 35a. The center portion surrounded by 4 inclined surfaces 36a, b defines a space 34, and the tube body T can be installed in this cavity 34. The distance between each of two sets of the opposed inclined surfaces 36a and 36b is slightly smaller than the outside diameter of the tube body T to allow the tube body T installed in the cavity 34 to be held between the opposing inclined surfaces. The tube body T is held in the cavity 34 by these four inclined surfaces 36a, b.

While each of the inclined surfaces 36a, b in the aforementioned embodiments has been formed in a flat surface, each of the inclined surfaces 36a, b may be formed in a concave surface conformable with the tube body T.

Within the tubing-retaining member 30, an upper cavity 38 is formed between the opening 33 and each of the sidewalls 20a, and a lower cavity 37 is formed somewhere between the bottom channel 35b and each of the sidewalls 20a. The pair of cavities 37, 38 facilitate elastic deformation of the tubing-retaining member 30. When the tube body is fitted into the tubing-retaining member 30, the upper cavities 38 are mainly deformed to allow the tube body T to be received in the tubing-retaining member 30.

When the tube body T is vibrated and displaced, the channels 35a, b and the cavities 37, 38 are operable to absorb the vibration. More specifically, when the tube body T is displaced sideward, the corresponding side channel 35s can be mainly deformed to absorb the displacement. When the tube body T is displaced downward, the bottom channel 35 can be mainly deformed. Further, when the tube body T is displaced obliquely, the corresponding inclined surface 36a, b and the corresponding cavity 37, 38 can be deformed to absorb the displacement.

In this vibration-proof clamp, vibration-proof performance is enhanced by the channels 35a, b and cavities 37, 38 formed in the tubing-retaining member 30.

The operation of attaching tubing to a vibration-proof clamp will be described below.

When a tube body T is fitted into the tubing-retaining member 30, the inclined surfaces 22 are pressed and bendingly deformed by the tube body T. The opening 33 of the tubing-retaining member 30 is expanded by the tube body T, and the upper cavities 38 are pushed and deformed.

After the tube body T is fitted into the space 34 in the tubing-retaining member 30, the inclined surfaces 22 are deformed and returned to their original shapes, and the width of the opening 33 is returned to former state. Thus, the tube body T is retained by the four inclined surfaces 36a, b so as not to drop off.

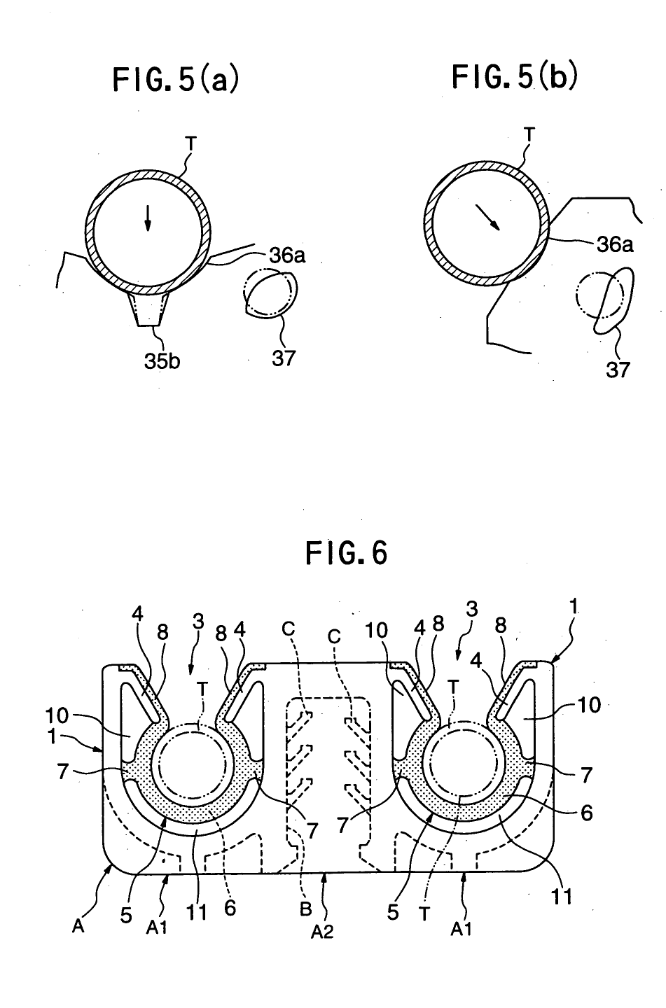

FIG. 5 is a schematic diagram showing the movement of the tubing-retaining member 30 when the tube body T is vibrated and displaced. FIG. 5(a) shows the movement of the tube body T when the tube body T is displaced downward. When the tube body T is displaced downward, the tube body T pushes the inclined surfaces 36a downward to increase the distance therebetween and expands the lower channel 35b, so as to absorb the displacement. When the tube body T is displaced sideward, the tube body T pushes the corresponding inclined surfaces 36a, b to increase the distance therebetween and expands the corresponding side channel 35a, so as to absorb the displacement. FIG. 5(b) shows the movement of the tube body T when the tube body T is displaced obliquely downward. When the tube body T is displaced obliquely, the tube body T pushes the corresponding inclined surface 36a downward to deform the corresponding cavity 37, so as to absorb the displacement. Thus, even if the tube body T is vibrated and displaced in any direction, the vibration is absorbed by the channels 35a, b and the cavities 37, 38.

Thus, this vibration-proof clamp can provide enhanced vibration-proof performance by the channels 35a, b and cavities 37, 38 formed in the tubing-retaining member 30.

As described above, the present invention can provide a vibration-proof clamp capable of achieving high vibration-proof performance with high reliability.

1. A vibration-proof clamp comprising:
a housing member having a rectangular housing space and a pair of inclined tabs each extending from a corresponding upper end thereof obliquely downward to define a tube body insertion opening between said inclined tabs; and
an elastic tubing-retaining member housed in said space of said housing member and adapted to hold a tube body, said tubing-retaining member including a plurality of inner tubing-retaining surfaces, a channel provided between the adjacent tubing-retaining surfaces, and a cavity formed within said tubing-retaining member, wherein
when said tube body is vibrated and displaced, said cavity and said channel are operable to absorb the displacement of said tube body so as to provide vibration-proof performance.

2. (Cancelled)

3. A vibration-proof clamp as described in claim 1, wherein said tubing-retaining surfaces of said tubing-retaining member are formed in a flat surface.

4. A vibration-proof clamp as described in claim 1, wherein said tubing-retaining surfaces are formed with a concave portion conformable with said tube body.

5. A vibration-proof clamp as described in claim 1, wherein said channel of said tubing-retaining member is formed to extend in the longitudinal direction of said tube body.

6. A vibration-proof clamp as described in claim 1, wherein said cavity of said tubing-retaining member is formed to extend in the longitudinal direction of said tube body.

7. A vibration-proof clamp as described in claim 1, wherein said housing member includes an undercut portion for retaining said tubing-retaining member.

8. A vibration-proof clamp as described in claim 1, wherein said inclined tabs are adapted to biasedly deform when said tube body passes through said tube body insertion opening.

9. A vibration-proof clamp as described in claim 1, wherein said tube body insertion opening remains unobstructed during use.

10. A vibration-proof clamp as described in claim 1, wherein said housing includes a plurality of spaced apart rectangular housing spaces separated by sidewalls.

11. A vibration-proof clamp as described in claim 10, wherein said spaced apart rectangular housing spaces are substantially similarly sized and shaped.

12. A vibration-proof clamp as described in claim 1, wherein said housing member includes an attaching portion positioned adjacent to said rectangular housing space.

13. A vibration-proof clamp as described in claim 12, wherein said attaching portion includes a plug hole and an engagement member, said engagement member being adapted to engage a fastener.

14. A vibration-proof clamp as described in claim 1, wherein said elastic tubing-retaining member includes an opening in communication with said cavity, said tubing-retainer member opening being aligned with said tube body insertion opening.

15. A method of supporting a tube on a structure comprising the steps of:
coupling a clamp as defined in claim 1 to the structure;
positioning said tube body within said cavity; and
biasedly engaging said elastic tubing-retaining member with said tube body.

16. The method of claim 15 further including biasedly engaging said inclined tabs with said tube body as said tube body is being positioned with said cavity.

17. A method of supporting a tube on a structure with a vibration-proof clamp, the clamp having a housing member including a rectangular housing space and an elastic tubing-retaining member having a plurality of spaced apart tubing retaining surfaces defining a cavity, the method comprising the steps of:
coupling the clamp to the structure; and
laterally translating a tube body to position the tube body within the cavity after the coupling step has occurred.

18. The method of claim 17 further including biasedly engaging the tube body with the tubing retaining surfaces.

19. The method of claim 18 further including biasedly engaging inclined tabs formed on the housing member with the tube body.

20. The method of claim 19 wherein the inclined tabs are spaced apart from one another to form an opening through which the tube body travels during the translating step.

21. A method of supporting a tube on a structure with a vibration-proof clamp, the clamp having a housing member including a rectangular housing space and an elastic tubing-retaining member having a plurality of spaced apart tubing-retaining surfaces defining a cavity, the method comprising the steps of:
orienting an opening of the elastic tubing-retaining member away from the structure such that a tube body may be laterally translated through the opening after the clamp is coupled to the structure;
coupling the housing member to the structure; and
positioning the tube body within the cavity.

22. The method of claim 21 wherein the step of coupling the housing member to the structure occurs after the positioning step has been completed.

23. The method of claim 21 further including biasedly engaging the tubing-retaining surfaces with the tube body.

24. The method of claim 21 further including coupling a plurality of elastic tubing-retaining members to the housing member.

25. The method of claim 24 further including positioning a tube body within a cavity of each elastic tubing-retaining member.

26. The method of claim 21 further including removing the tube body from the cavity while the housing is coupled to the structure.
